(19) United States
(12) Patent Application Publication
(10) Pub. No.: US 2022/0317685 A1
(43) Pub. Date: Oct. 6, 2022

(54) REMOTE DRIVING SYSTEM, REMOTE DRIVING DEVICE, AND TRAVELING VIDEO DISPLAY METHOD

(71) Applicant: WOVEN PLANET HOLDINGS, INC., Tokyo (JP)

(72) Inventor: Toshinobu WATANABE, Setagaya-ku (JP)

(73) Assignee: WOVEN PLANET HOLDINGS, INC., Tokyo (JP)

(21) Appl. No.: 17/710,252

(22) Filed: Mar. 31, 2022

(30) Foreign Application Priority Data
Apr. 5, 2021 (JP) 2021-064376

(51) Int. Cl. G05D 1/00

(52) U.S. Cl. CPC G05D 1/0038; G05D 1/0022; G05D 2201/0213

(57) ABSTRACT

A remote driving system for a vehicle comprises a remote driving device. The remote driving device comprises a driving operation device configured to receive input of driving operation, a display device, and one or more processors. The one or more processors are configured to execute a process of calculating a delay time relating to communication and processing between the vehicle and the remote driving device, a process of calculating a predictive driving operation, a process of generating a first estimate traveling path and a second estimate traveling path, and a display process of displaying the traveling video on the display device. The display process includes superimposing the first estimate traveling path and the second estimate traveling path on the traveling video.

### CROSS-REFERENCE TO RELATED APPLICATION

The present disclosure claims priority under 35 U.S.C. §119 to Japanese Patent Application No. 2021-064376, filed on Apr. 5, 2021, which is incorporated herein by reference in its entirety.

### BACKGROUND

### Technical Field

The present disclosure relates to a system and a device for performing remote driving of a vehicle, and a display method of a display for remote driving of the vehicle.

### Background Art

Patent Literature 1 discloses a display device for remote control of a moving object. The display device displays an environment viewed from the moving object when a person operates a remote control device. The display device comprises an image generating device configured to generate a three-dimensional CG image based on environmental data representing the environment of the traveling direction side of the moving object, and a display device that displays the generated CG image. The image generating device predicts a position of the moving object at a future time point based on delay time considering the communication between the moving object and the remote control device, and generates the CG image.

Further, as the prior art representing the technical level of the technical field to which the present disclosure belongs, there are Patent Literature 2 and Patent Literature 3.

### LIST OF RELATED ART

Patent Literature 1: Japanese Laid-Open Patent Application Publication No. JP-2019-049888

Patent Literature 2: Japanese Laid-Open Patent Application Publication No. JP-2018-106676

Patent Literature 3: Japanese Laid-Open Patent Application Publication No. JP-2010-61346

### SUMMARY

In remote driving of a vehicle, since an operator of a remote driving device cannot obtain driving feeling sufficiently as compared with normal driving, driving operation is difficult. Therefore, a technology for improving operability of the operator is required.

In the display device disclosed in Patent Literature 1, the CG image (traveling video) viewed from the moving object (vehicle) at the predicted position is displayed. However, in remote driving the driving operation is delayed and act on the vehicle because of communication between the vehicle and the remote driving system. Therefore, just by displaying the CG image (traveling video) of the vehicle, it is possible not to improve the operability of the operator sufficiently. Especially, the operator cannot confirm how the vehicle is going to travel by the driving operation after the vehicle pass the predicted position.

An object of the present disclosure to provide a technique that can sufficiently improve the operability of the operator when the operator operates the remote driving device.

A first aspect is directed to a remote driving system for a vehicle.

The remote driving system comprises:
a camera configured to take an image of a traveling video of the vehicle;
a sensor configured to detect a traveling state of the vehicle; and
a remote driving device.

The remote driving comprises:
a driving operation device configured to receive an input of driving operation;
a display device; and
one or more processors.

The one or more processors is configured to execute:
a process of acquiring the traveling video of the vehicle;
a process of acquiring the traveling state of the vehicle;
a process of calculating a delay time relating to communication and processing between the vehicle and the remote driving device;
a process of calculating a predictive driving operation from a present time point to a predetermined elapsed time point based on the input of driving operation received up to the present time point by the driving operation device;
a process of calculating a predictive driving operation from a present time point to a predetermined elapsed time point based on the input of driving operation received up to the present time point by the driving operation device;
a process of calculating an action time point based on the delay time, the action time point being a time point when the input of driving operation at the present time point acts on the vehicle;
a process of generating a first estimate traveling path based on the traveling state, the input of driving operation received by the driving operation device, and the delay time, the first estimate traveling path being a traveling path from a time point of taking the image of the traveling video to the action time point;
a process of generating a second estimate traveling path, the second estimate traveling path being a traveling path after the action time point by the predictive driving operation; and
a display process of displaying the traveling video on the display device, wherein the display process includes superimposing the first estimate traveling path and the second estimate traveling path on the traveling video.

The one or more processors may be further configured to execute a process of generating a third estimate traveling path, the third estimate traveling path being a traveling path after the action time point in a case where the input of driving operation at the present time point maintains up to the predetermined elapsed time. And the display process includes superimposing the third estimate traveling path on the traveling video.

The delay time may include a reaction time of an operator operating the remote driving device.

A second aspect is directed to a remote driving device for a vehicle.

The remote driving device comprises:
a driving operation device configured to receive an input of driving operation;
a display device; and
one or more processors.

The one or more processors is configured to execute:
a process of acquiring a traveling video of the vehicle;
a process of acquiring a traveling state of the vehicle;
a process of calculating a delay time relating to communication and processing between the vehicle and the remote driving device;
a process of calculating a predictive driving operation from a present time point to a predetermined elapsed time point based on the input of driving operation received up to the present time point by the driving operation device;
a process of calculating an action time point based on the delay time, the action time point being a time point when the input of driving operation at the present time point acts on the vehicle;
a process of generating a first estimate traveling path based on the traveling state, the input of driving operation received by the driving operation device, and the delay time, the first estimate traveling path being a traveling path from a time point of taking the image of the traveling video to the action time point;
a process of generating a second estimate traveling path, the second estimate traveling path being a traveling path after the action time point by the predictive driving operation; and
a display process of displaying the traveling video on the display device, wherein the display process includes superimposing the first estimate traveling path and the second estimate traveling path on the traveling video.

The one or more processors may be further configured to execute a process of generating a third estimate traveling path, the third estimate traveling path being a traveling path after the action time point in a case where the input of driving operation at the present time point maintains up to the predetermined elapsed time. And the display process includes superimposing the third estimate traveling path on the traveling video.

A third aspect is directed to a method of displaying a traveling video of a vehicle on a display device of a remote driving device.

The remote driving device comprises a driving operation device configured to receive input of driving operation.

The method comprises:
acquiring the traveling video of the vehicle;
acquiring a traveling state of the vehicle;
calculating a delay time relating to communication and processing between the vehicle and the remote driving device;
calculating a predictive driving operation from a present time point to a predetermined elapsed time point based on the input of driving operation received up to the present time point by the driving operation device;
calculating an action time point based on the delay time, the action time point being a time point when the input of driving operation at the present time point acts on the vehicle;
generating a first estimate traveling path based on the traveling state, the input of driving operation received by the driving operation device, and the delay time, the first estimate traveling path being a traveling path from a time point of taking the image of the traveling video to the action time point;
generating a second estimate traveling path, the second estimate traveling path being a traveling path after the action time point by the predictive driving operation; and
displaying the traveling video on the display device, wherein displaying the traveling video on the display device includes superimposing the first estimate traveling path and the second estimate traveling path on the traveling video.

The method further comprises the computer to execute a process generating a third estimate traveling path, the third estimate traveling path being a traveling path after the action time point in a case where the input of driving operation at the present time point maintains up to the predetermined elapsed time, wherein displaying the traveling video on the display device includes superimposing the third estimate traveling path on the traveling video.

According to the present disclosure, the traveling video on which the first estimate traveling path and the second estimate traveling path are superimposed is displayed on the display device. It is thus possible to let the operator confirm continuously how the vehicle is going to travel by its own driving operation. Then, it is possible to reduce the difficulty of driving operation for remote driving and improve the operability of the operator.

And the estimate traveling path (the first estimate traveling path and the second estimate traveling path) is generated in the remote driving device. It is thus possible to generate the estimate traveling path without the information of the driving operation is affected by communication between the vehicle and the remote driving device. Then, it is possible to generate the estimate traveling path more accurately.

Furthermore, the second estimate traveling path is generated based on the predictive driving operation. It is thus possible to let the operator confirm continuously how the vehicle is estimated to travel by the tendency of driving operation. Then, it is possible to improve the operability of the operator.

### BRIEF DESCRIPTION OF THE DRAWINGS

FIG. 1 is a conceptual diagram for explaining an outline of a remote driving system according to an embodiment of the present disclosure;

FIG. 2A is a conceptual diagram for explaining an outline of a traveling video displayed on a display device of a remote driving device in the remote driving system according to an embodiment of the present disclosure;

FIG. 2B is a conceptual diagram for explaining an outline of a traveling video displayed on a display device of a remote driving device in the remote driving system according to an embodiment of the present disclosure;

FIG. 3 is a block diagram for explaining a configuration of the remote driving system according to an embodiment of the present disclosure;

FIG. 4 is a block diagram for explaining a configuration of an processing device shown in FIG. 3;

FIG. 5 is a flow chart showing in a summarized manner the processing for displaying the traveling video on the display device;

FIG. 6 is a conceptual diagram for explaining a delay time between the vehicle and the remote driving device;

FIG. 7 is a flow chart showing in a summarized manner the processing executed by the information processing apparatus executes in an estimate traveling path generation process shown in FIG. 5:

FIG. 8 is a conceptual diagram for explaining an example of a predictive driving operation calculated in a predictive driving operation calculation process shown in FIG. 7;

FIG. 9 is a conceptual diagram showing the traveling video displayed on the display device in the remote driving system according to a first modification of an embodiment of the present disclosure;

FIG. 10A is a conceptual diagram showing the traveling video displayed on the display device in the remote driving system according to a second modification example of an embodiment of the present disclosure.

FIG. 10B is a conceptual diagram showing the traveling video displayed on the display device in the remote driving system according to a second modification example of an embodiment of the present disclosure.

### EMBODIMENTS

Hereinafter, embodiments of the present disclosure will be described with reference to the accompanying drawings. Note that when the numerals of numbers, quantities, amounts, ranges and the like of respective elements are mentioned in the embodiment shown as follows, the present disclosure is not limited to the mentioned numerals unless specially explicitly described otherwise, or unless the disclosure is explicitly specified by the numerals theoretically. Furthermore, configurations that are described in the embodiment shown as follows are not always indispensable to the disclosure unless specially explicitly shown otherwise, or unless the disclosure is explicitly specified by the structures or the steps theoretically.

### 1. Outline

### 1-1. Remote Driving System

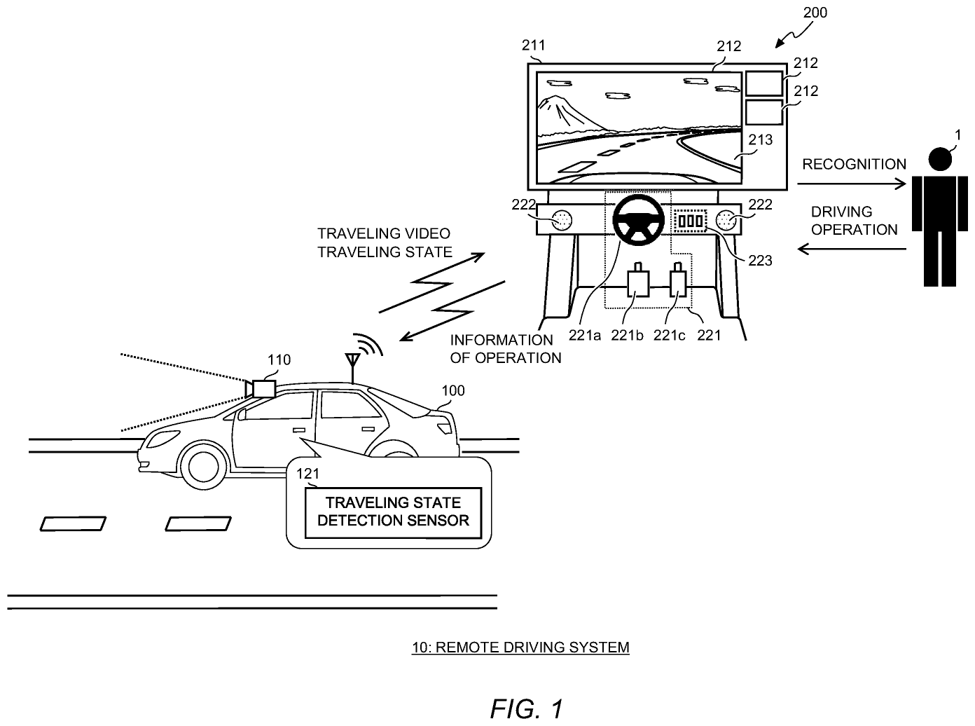

FIG. 1 is a conceptual diagram for explaining an outline of a remote driving system 10 according to the present embodiment. The remote driving system 10 is a system performing remote driving of a vehicle 100. The remote driving system 10 comprises a remote driving device 200 to drive the vehicle 100 remotely. The vehicle 100 and the remote driving device 200 are configured to be able to communicate with each other, and constitute a communication network.

The remote driving of the vehicle 100 is performed by driving operation which is given by an operator 1 operating the remote driving device 200. Here, the vehicle 100 may be configured to be driven by other means. For example, the vehicle 100 may be configured to be driven manually by operating an operation device comprised in the vehicle 100 (e.g., a steering wheel, a gas pedal, and a brake pedal). Or the vehicle 100 may be configured to be driven autonomously by an autonomous driving control performed by a control device comprised in the vehicle 100. That is, the vehicle 100 may be a vehicle capable of remote driving when control of driving operation is transferred to the remote driving device 200.

The vehicle 100 comprises a camera 110. The camera 110 is placed to be able to take an image in front of the vehicle 100. And the camera 110 outputs the image of a traveling video 213 in front of the vehicle 100. However, the vehicle 100 may comprises other cameras taking the image of the traveling video 213 in other sides of the vehicle 100. Information of the traveling video 213 output by the camera 110 is transmitted to the remote driving device 200 by communication.

The vehicle 100 comprises a traveling state detection sensor 121 detecting a traveling state (e.g., a vehicle speed, an acceleration, and a yaw rate) of the vehicle 100. Examples of the traveling state detection sensor 121 include a wheel speed sensor detecting the vehicle speed, an acceleration sensor detection the acceleration, an angular velocity sensor detecting the yaw rate, and the like. Information of the traveling state detected by the traveling state detection sensor 121 is transmitted to the remote driving device 200 by communication.

The vehicle 100 may comprise other sensors, and information detected by other sensors is transmitted to the remote driving device 200 by communication.

The remote driving device 200 comprises an output device for informing the operator 1 of information. The output device at least includes a display device 211 displaying various displays for informing the operator 1 of information. In FIG. 1 further as the output device, a speaker 222 is shown which making various sounds for informing the operator 1 of information. The output device may include other devices. The output (e.g., a display, a sound) of the output device is controlled by a processing device (not shown in FIG. 1) comprised in the remote driving device 200.

The display device 211 at least displays the traveling video 213 acquired from the vehicle 100. The display device 211 may include a plurality of display portions 212. And the display device 211 may display a plurality of displays on the plurality of display portions 212.

The speaker 222 typically makes sound depending on the display displayed by the display device 211. For example, depending on the traveling video 213 the speaker 222 makes environmental sound of the vehicle 100 (e.g., external environment sound, engine drive sound, and road noise). In this case, the speaker 222 may make sound recorded by a microphone comprised in the vehicle 100. Or the speaker 222 may make sound generated or selected by a processing device comprised in the remote driving device 200 based on the information of the traveling state acquired from the vehicle 100.

The remote driving device 200 comprises an input device receiving an input of operation of the operator 1. The input device at least includes a driving operation device 221 receiving the input of driving operation of the operator 1. In FIG. 1 further as the input device, a switch 223 is shown which receiving the input of various operations. Examples of the switch 223 includes a switch for switching the display on the display device 211, a switch to end remote driving of the vehicle 100, and the like.

In FIG. 1 as examples of the driving operation device 221, a steering wheel 221a, a gas pedal 221b, and a brake pedal 221c are shown. By operating the driving operation device 221, remote driving of the vehicle 100 is performed.

The operator 1 usually recognizes information informed by the output device and operates the input device based on the recognized information. Especially, the operator 1 sees the traveling video on the display device 211 and operates the driving operation device 221 so that the vehicle 100 performs the desired traveling.

Information of driving operation input in the driving operation device 221 is transmitted to the vehicle 100. The vehicle 100 travels depending on the information of driving operation. Here the traveling of the vehicle 100 is realized by a control device (not shown in FIG. 1) transmitting control signals depending on the information of driving operation to a plurality of actuators comprised in the vehicle 100. Then remote driving of the vehicle 100 is realized.

### 1-2. Display Of Estimate Traveling Path

Since the operator 1 drives the vehicle 100 remotely by the remote driving device 200, the operator 1 cannot obtain driving feeling sufficiently as compared with normal driving. Therefore, driving operation is difficult as compared with normal driving. In this regard as a means for improving the operability of the operator 1, it is considered to superimpose an estimate traveling path on the traveling video 213. Here, the estimate traveling path is a traveling path that the vehicle 100 is estimated to travel by driving operation input in the driving operation device 221.

However, because of communication between the vehicle 100 and the remote driving device 200, the traveling video 213 displayed on the display device 211 is the image taken in a certain amount of time ago. Therefore, superimposing the estimate traveling path on the traveling video 213 without considering communication between the vehicle 100 and the remote driving device 200, the difficulty of driving operation may not be improved. That is, the operability of the operator 1 may not be improved.

Thus, in the remote driving system 10 according to the present embodiment, the estimate traveling path superimposed on the traveling video 213 is displayed considering a delay time between the vehicle 100 and the remote driving device 200. Here, the delay time includes a time relating to communication and processing between the vehicle 100 and the remote driving device 200. Details of the delay time will be described later.

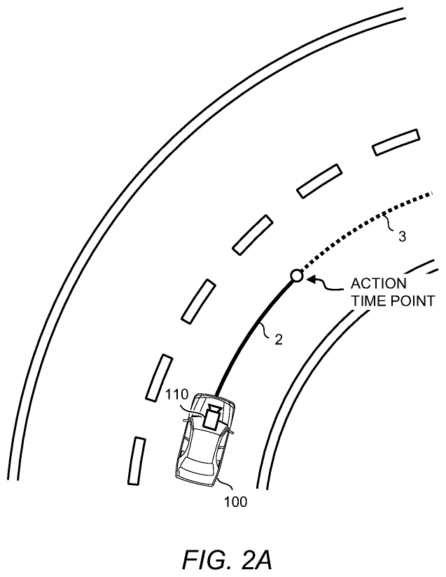

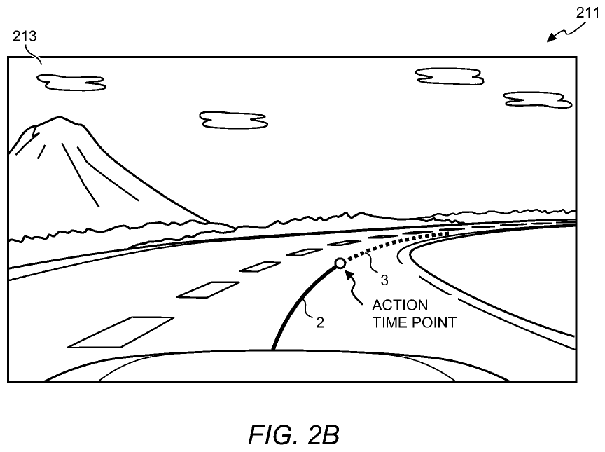

FIG. 2A and FIG. 2B are a conceptual diagram for explaining an outline of the traveling video 213 displayed on the device 211 of the remote driving device 200 in the remote driving system 10 according to the present embodiment. FIG. 2A and FIG. 2B illustrate a case when the operator 1 drives the vehicle 100 remotely on a right curved road. Here, FIG. 2A illustrates a top view representing the situation of traveling of the vehicle 100. And FIG. 2B illustrates the traveling video 213 displayed on the display device 200 in the situation illustrated in FIG. 2A. As shown in FIG. 2B, the image of the traveling video 213 taken by the camera 110 is displayed on the display device 211. Furthermore, two types of the estimate traveling path, that is a first estimate traveling path 2 (solid line) and a second estimate traveling path 3 (dotted line), are superimposed on the traveling video 213.

Hereinafter, a time point when the traveling video 213 displayed on the display device 211 is taken by the camera 110 is also referred to as the “time point of taking image”. And a time point when the input of driving operation at a present time point acts on the vehicle is also referred to as the “action time point”. Here, the present time point is equivalent to a time point when the traveling video 213 taken at the time point of taking image is displayed on the display device 211.

The first estimate traveling path 2 is the estimate traveling path in which the vehicle 100 is estimated to travel by the input of driving operation up to the present time point. Thus, the first estimate traveling path 2 shows a traveling path from the time point of taking image to the action time point.

The second estimate traveling path 3 is the estimate traveling path in which the vehicle 100 is estimated to travel by a predictive driving operation. Here the predictive driving operation is a predicted value of driving operation in the driving operation device 221 from the present time point to a predetermined elapsed time point. The predictive driving operation is calculated based on the input of driving operation up to the present time point in the driving operation device 221. Thus, the second estimate traveling path 3 shows a traveling path after the action time point.

Furthermore, a mark representing the action time point may be displayed on the traveling video 213. In FIG. 2A and FIG. 2B, a white circle is displayed on the traveling video 213 as the mark.

Here, the present time point and the action time point relative to the time point of taking image depend on the delay time between the vehicle 100 and the remote driving device 200. Therefore, the first estimate traveling path 2 and the second estimate traveling path 3 are generated considering the delay time between the vehicle 100 and the remote driving device 200.

Note that the first estimate traveling path 2 and the second estimate traveling path 3 are generated in the remote driving device 200. It is thus possible to generate the first estimate traveling path 2 and the second estimate traveling path 3 without that the input of driving operation up to the present time point is affected by the communication between the vehicle 100 and the remote driving device 200.

The operator 1 can confirm continuously how the vehicle 100 is going to travel by its own driving operation, seeing the first estimate traveling path 2 and the second estimate traveling path 3 superimposed on the traveling video 213.

As described above, the remote driving system 10 according to the present embodiment superimpose the first estimate traveling path 2 and the second estimate traveling path 3 on the traveling video 213. Here the first estimate traveling path 2 and the second estimate traveling path 3 are generated considering communication between the vehicle 100 and the remote driving device 200. It is thus possible to reduce the difficulty of driving operation for remote driving and improve the operability of the operator 1.

### 2. Configuration Example

### 2-1. Remote Driving System

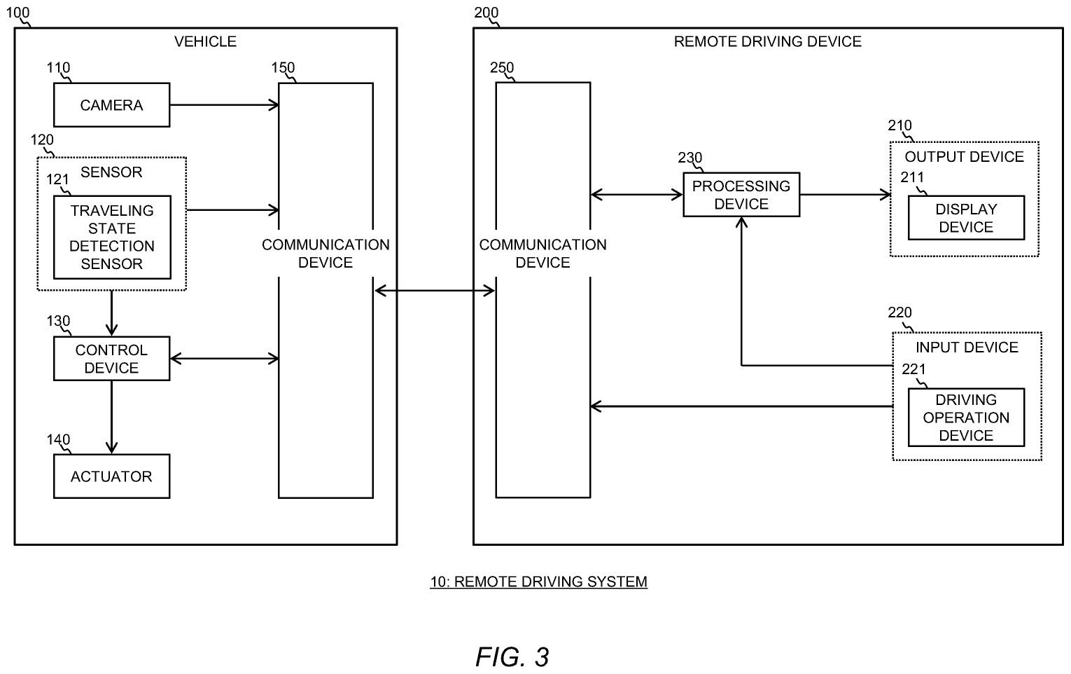

FIG. 3 is a block diagram for explaining a configuration of the remote driving system 10 according to the present embodiment. The remote driving system 10 includes the vehicle 100 and the remote driving device 200.

The vehicle 100 comprises the camera 110, a sensor 120, a control device 130, an actuator 140, and a communication device 150. The control device 130 is configured to be able to transmit information to and receive information from the sensors 120, the actuator 140, and the communication device 150. Similarly, the communication device 150 is configured to be able to transmit information to and receive information form the camera 110, a sensor 120, and the control device 150. Typically, these devices are connected each other by wire harnesses and in-vehicle networks are constructed.

The camera 110 is configured to take the image of the traveling video 213 of the vehicle 100 and output information of the image of the traveling video 213. Here, information of the image of the traveling video 213 output by the camera 110 includes information of the time point of taking image. The camera 110 at least takes the image of the traveling video 213 in front of the vehicle 100. The camera 110 may include some cameras taking the image of the traveling video in other sides of the vehicle 100. In this way, the camera 110 may mean a plurality of cameras.

The sensor 120 is configured to detect information of a driving environment of the vehicle 100 and output a detection information. The sensor 120 includes the traveling state detection sensor 121. The traveling state detection sensor 121 at least detects the traveling state of the vehicle 100. That is, the detection information output by the sensor 120 includes information of the traveling state of the vehicle 100. Here, information of the traveling state detected by the traveling state detection sensor 121 includes information of a time point when the traveling state is detected. The other examples of the sensor 120 include a sensor (e.g., a radar, an image sensor, a LiDAR) detecting information of surrounding environment of the vehicle 100 (e.g., a preceding vehicle, a lane, an obstacle).

The control device 130 executes various processes relating to the control of the vehicle 100 based on information to be acquired, and generates a control signal. Then, the control device 130 outputs the control signal. The control device 130 is typically an ECU (Electronic Control Unit) comprising one or more memories and one or more processors. The one or more memories includes a RAM (Random Access Memory) for temporarily storing data and a ROM (Read Only Memory) for storing various data and a program that can be executed by the processor. Information acquired by the control device 130 is stored in the one or more memories. The one or more processor reads the program from the one or more memories and executes processing according to the program based on various data read from the memory.

Information which the control device 130 acquires includes the detection information acquired from the sensor 120 and a communication information acquired from the communication device 150. Especially, the communication information acquired from the communication device 150 includes information of driving operation input in the driving operation device 221. Information acquired by the control device 130 may include other information. For example, information acquired from an operation device and an HMI device comprised in the vehicle 100 (not shown in FIG. 3) may be included.

The control device 130 executes at least, based on information of driving operation to be acquired, a process for realizing the traveling of the vehicle 100. That is the control device 130 generates and outputs the control signal based on information of driving operation (e.g., steering angle, accelerator opening, depression amount of brake pedal) to be acquired.

Here, the various processes executed by the control device 130 may be provided as a part of one program, or may be provided by a separate program for each process or for group of processes. Alternatively, each process or group of processes may be executed by a separate ECU. In this case, the control device 130 is configured to include a plurality of ECUs.

The actuator 140 operates in accordance with the control signal acquired from the control device 130. Examples of the actuator 140 includes an actuator that drives an engine (e.g., an internal combustion engine, an electric motor), an actuator that drives a braking mechanism comprised in the vehicle 100, an actuator that drives a steering mechanism, and the like. By operating of the actuator 140 in accordance with the control signal acquired from the control device 130, the various controls of the vehicle 100 by the controller 130 are realized. Especially, remote driving of the vehicle 100 by the remote driving device 200 is realized.

The communication device 150 is a device for transmitting information to and receiving information from an external device of the vehicle 100. The communication device 150 is at least configured to be able to transmit information to and receive information form the remote driving device 200. For example, the communication device 150 is a device performing mobile communication with a base station to which the remote driving device 200 is connected. Other examples of the communication device 150 includes a device for performing vehicle-to-vehicle communication and road-to-vehicle communication, a GPS receiver, and the like. In this way, the communication device 150 may mean a plurality of devices.

The communication information transmitted by the communication device 150 includes at least information of the image of the traveling video 213 acquired from the camera 110, and information of the traveling state acquired from the traveling state detection sensor 121. The communication information received by the communication device 150 includes at least information of driving operation input in the driving operation device 221. The communication device 150 outputs the received communication information.

The remote driving device 200 comprises the output device 210, the input device 220, processing device 230, and a communication device 250. The processing device 230 is configured to be able to transmit information to and receive information from the output device 210, input device 220, and the communication device 250. Similarly, the communication device 250 is configured to be able to transmit information to and receive information from the processing device 230 and the input device 220.

The output device 210 is a device informs the operator 1 of information of the remote driving device 200. The output device 210 operates in accordance with a control signal acquired from the processing device 230. The output device 210 includes at least a display device 211. The output device 210 may include other devices like the speaker 222 shown in FIG. 1.

The display device 210 performs various displays for informing the operator 1 of information. The display device 210 at least displays the traveling video 213 of the vehicle 100. The form of the display device 210 is not particularly limited. Examples of the display device 210 include a liquid crystal display, a OLED display, a head-up display, head-mounted display, and the like.

The input device 220 is a device receives an input of operation by the operator 1. The input device 220 includes at least the driving operation device 221. The input device 220 may include other devices like the switch 223 as shown in FIG. 1.

The driving operation device 221 is a device receives the input of driving operation of the vehicle 100 (e.g., steering, acceleration, braking). Typically, as shown in FIG. 1, the driving operation device 221 includes the steering wheel 221a, the gas pedal 221b, and the brake pedal 221c.

The driving operation device 221 outputs information of the received input of driving operation. Here, Information of driving operation output by the driving operation device 221 includes information of a time point when driving operation is input.

The processing device 230 executes various processes relating to the remote driving device 200 based on information to be acquired, and generates the control signal. Then, the processing device 230 outputs the control signal. The processing device 230 is typically a computer comprising a one or memory and one or more processors.

Information which the processing device 230 acquires includes information of driving operation acquired from the driving operation device 221, and information of a communication information acquired from the communication device 250. Information acquired by the processing device 230 is stored in the one or more memories. Especially, information of the input of driving operation for a predetermined period and information of the traveling state for the predetermined period are stored in one or more memories.

The processing device 230 executes at least a process for controlling the output device 210. Especially, the processing device 230 executes a process for displaying the traveling video 213 on the display device 211.

The communication device 250 is a device for transmitting information to and receiving information from the vehicle 100. For example, the communication device 250 is a device transmitting and receiving information via a base station communicating with the vehicle 100.

The communication information transmitted by the communication device 250 includes at least information of driving operation input in the driving operation device 221. The communication information received by the communication device 250 includes at least information of the image of the traveling video 213, and information of the traveling state of the vehicle 100.

The devices comprised in the remote driving device 200 may not be integral. For example, the processing device 230 may be an external server configured on a communication network such as the interne. And the processing device 230 may communicate with the output device 210, the input device 220, and the communication device 250 via the communication network. Furthermore, the output device 210 and the input device 220 may be a separate device respectively, and may transmit and receive information by communication.

### 2-2. Processing Device

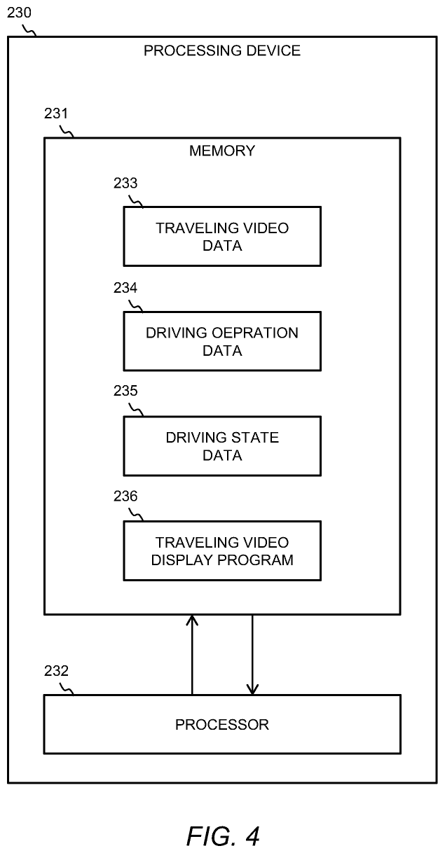

FIG. 4 is a block diagram for explaining a configuration of the processing device 230. The processing device 230 comprises a memory 231 and a processor 232.

The memory 231 stores a traveling video data 233, a driving operation data 234, traveling state data 235, and a traveling video display program 236. The memory 231 may store other data and programs, or other information.

The traveling video data 233 is a data of traveling video 213 acquired from the camera 110. The driving operation data 234 is a time-series data of the driving operation for the predetermined period input in the driving operation device 221. The traveling state data 235 is a time-series data of the traveling state for the predetermined period detected by the traveling state detection sensor 121. Here the period for storing data about the driving operation data 234 and the traveling state data 235 is a period sufficiently longer than the delay time between the vehicle 100 and the remote driving device 200. For example, the memory 231 stores these data for 10 sec.

The traveling video display program 236 is a program relating to processing for displaying the traveling video 213 on the display device 210.

The processor 232 reads a program from the memory 231 and executes processing according to the program based on various data read from the memory 231. Especially, the processor 232 reads the traveling video display program 236 and executes processing for displaying the traveling video 213 on the display device 210 according to the traveling video display program 236. Thus, the control signal for displaying the traveling video 231 on the display device 211 is generated. And the generated control signal is transmitted to the display device 211. And the display device 211 operates in accordance with the control signal, then the traveling video 231 is displayed on the display device 211. Details of the processing according to the traveling video display program 236 executed by the processor 232 will be described later.

### 3. Processing

### 3-1. Processing According to The Traveling video Display Program

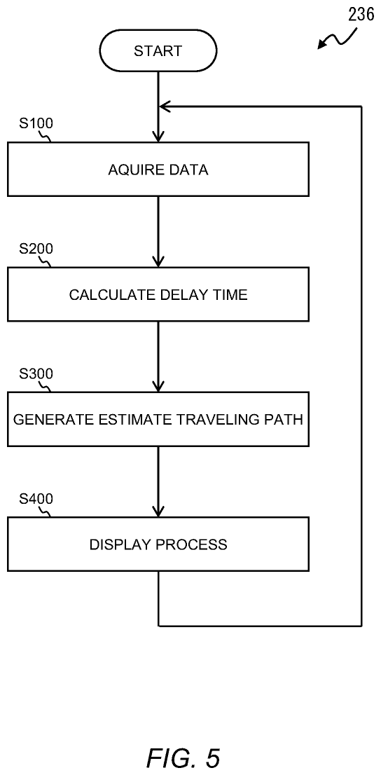

FIG. 5 is a flow chart showing the processing executed by the processor 232 according to the traveling video display program 236. The processing shown in FIG. 5 starts as the same timing as the activation of the remote driving device 200, and is repeatedly executed at a predetermined interval.

In Step S100, the processor 232 acquires data to display the traveling video 213. The processor 232 acquires at least the traveling video data 233, the driving operation data 234, and the traveling state data 235. Then processing proceeds to Step S200.

In Step S200, the processor 232 calculates the delay time between the vehicle 100 and the remote driving device 200. Details of the delay time calculated in Step S200 will be described later. Then processing proceeds to Step S300.

In Step S300, the processor 232 generates the first estimate traveling path 2 and the second estimate traveling path 3. Details of the processing executed in Step S300 will be described later.

In Step S400, the processor 232 executes the processing for displaying the traveling video 213 on which the first estimate traveling path 2 and the second estimate traveling path 3 are superimposed. Then processing proceeds to Step S100 again.

### 3-2. Calculate Delay Time

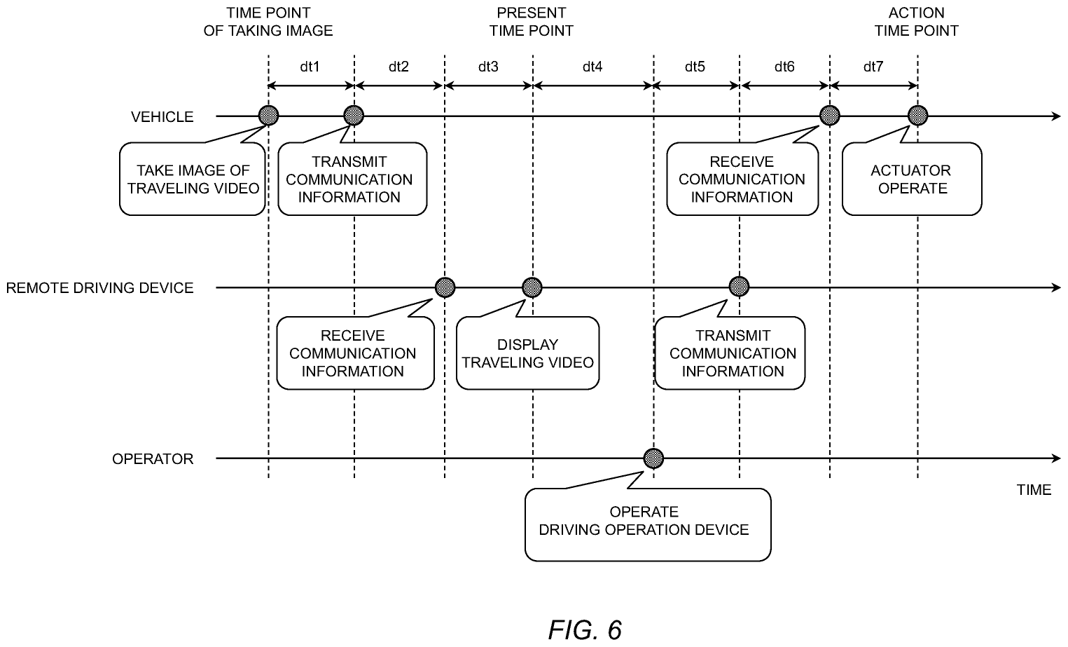

The processor 232 calculates the delay time between the vehicle 100 and the remote driving device 200 (in Step S200 in FIG. 5). FIG. 6 is a conceptual diagram for explaining the delay time between the vehicle 100 and the remote driving device 200.

FIG. 6 shows the events (indicated by circles) in the vehicle 100, the remote driving device 200, and the operator 1 respectively along the flow of time. And FIG. 6 shows the time period dti (i=1 to 7) elapsed between the respective events. That is, the processor 232 calculates the respective time period dti as the delay time between the vehicle 100 and the remote driving device 200.

The time period dt1 is a time period elapsed from the time point of taking image to a time point when the communication information is transmitted from the vehicle 100. Here, the transmitted communication information includes information of the traveling video 213 and the traveling state. In other words, the time period dt1 is delay time according to processing executed in the vehicle 100 for transmitting the communication information. The time period dt1 is, for example, calculated by measuring processing time in the camera 110, the sensor 120, and the communication device 150. For calculating the time period dt1, the average value of processing time measured in the past may be used. Furthermore, the shutter speed of the camera 110 may be added to the time period dt1. In this case, for example, the shutter speed is given by the spec of the camera 110.

The time period dt2 is a time period elapsed from the time point when the communication information is transmitted from the vehicle 100 to a time point when the communication information is received in the remote driving device 200. In other words, the time period dt2 is delay time according to the uplink of communication between the vehicle 100 and the remote driving device 200. The time period dt2 is, for example, calculated from a difference between the time when the communication information is transmitted from the vehicle 100 and the time when the communication information is received in the remote traveling video 200. In this regard, by synchronizing the times of the vehicle 100 and the remote driving device 200 using a NTP server on the communication network, the difference can be calculated accurately.

The time period dt3 is a time period elapsed from the time point when the communication information is received in the remote driving device 200 to a time point when the traveling video 213 is displayed on the display device 211. In other words, the time period dt3 is delay time according to processing for displaying the traveling video 213 in the remote deriving device 200. The time period dt3 is, for example, calculated by measuring processing time in the display device 211, the processing device 230, and the communication device 250. For calculating time period dt3, the average value of processing time measured in the past may be used. Furthermore, it is also possible to estimate delay time by considering the amount of data of the traveling video 213.

The time period dt4 is a time period elapsed from the present time point to a time when the operator 1 recognizes the traveling video 213 and operates the driving operation device 221. In other words, the time period dt4 is a reaction time of the operator 1. The time period dt4 is, for example, given by the general person's reaction time (e.g., 200 msec).

The time period dt5 is a time period elapsed from a time point when the input of driving operation is received by the driving operation device 221 to a time point when the communication information is transmitted from the remote driving device 200. Here, the transmitted communication information includes information of the input of driving operation. In other words, the time period dt5 is delay time according to processing executed in the remote driving device 200 for transmitting the communication information. The time period dt5 is, for example, calculated by measuring processing time in the driving operation device 221 and the communication device 250. For calculating the time period dt5, the average value of processing time measured in the past may be used.

The time period dt6 is a time period elapsed from the time point when the communication information is transmitted from the remote driving device 200 to a time point when the communication information is received in the vehicle 100. In other words, the time period dt6 is delay time according to the downlink of communication between the vehicle 100 and the remote driving device 200. The time period dt6 may be calculated as same as the time period dt2.

The time period dt7 is a time period elapsed form the time point when the communication information is received in the vehicle 100 to the action time point. In other words, the time period dt7 is delay time according to processing for operating the actuator 140. The time period dt7 is, for example, calculated by measuring processing time in the control device 130 and the communication device 150. For calculating time period dt7, the average value of processing time measured in the past may be used. Furthermore, the start time of the actuator 140 may be added to the time period dt7. In this case, for example, the start time is given by the spec of the actuator 140.

In this way the processor 232 calculates the time period dti. However, the frequency of calculating and updating the time period dti may be different in each of the time period dti respectively. For example, while the time period dt2 and the time period dt6 may be always updated when the processor 232 calculate the delay time, the time period dt5 and dt7 may be updated only at the specific timing.

Hereinafter, the sum of the time period dti (i=1 to 7) is also referred to as the “total delay time”. And the sum of the time period dt1, dt2, and dt3 is also referred to as the “display delay time”. And the sum of the time period dt4, dt5, dt6, and dt7 is also referred to as the “action delay time”.

### 3-3. Generate First Estimate Traveling Path

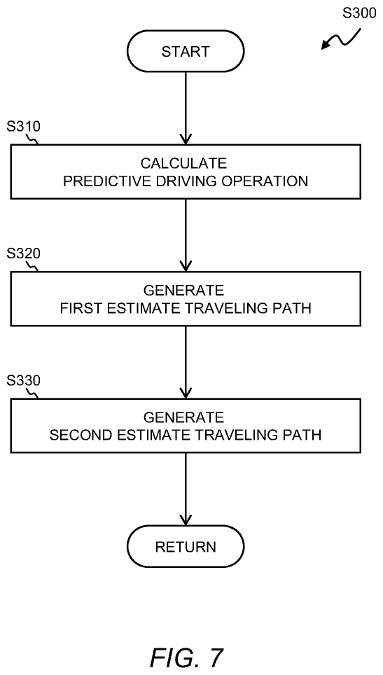

The processor 232 generates the estimate traveling path (in Step S300 in FIG. 5). Hereinafter, the processing executed by the processor 232 for generating the estimate traveling path is referred to as the “estimate traveling path generation process”. FIG. 7 is a flow chart showing the processing executed by the processor 232 in the estimate traveling path generation process.

In Step S310, the processor 232 calculates the predictive driving operation. The predictive driving operation is calculated based on the input of driving operation received up to the present time point by the driving operation device 221. Here, the predictive driving operation is calculated for each of the devices included in the driving operation device 221 (e.g., the steering wheel 221a, the gas pedal 221b, the brake pedal 221c). Further, the predetermined time of the predictive driving operation may be experimentally and optimally determined in accordance with the environment to which the remote driving system 10 according to the present embodiment is applied.

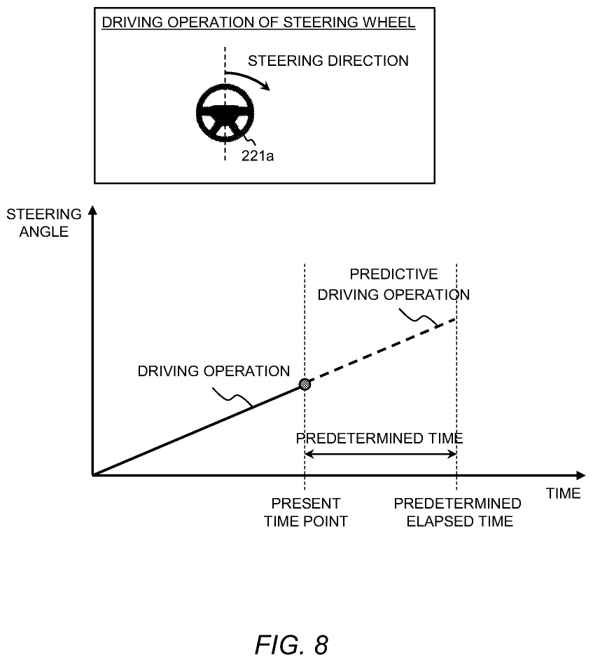

FIG. 8 is a conceptual diagram for explaining an example of the predictive driving operation relating to the steering wheel 221a. FIG. 8 shows a case when the operator 1 is operating the steering wheel 221a in the clockwise direction. The case is, for example, when the vehicle 100 is traveling on a road that curves to the right.

Now, it is assumed that driving operation of the steering wheel 221a (solid line shown in FIG. 8) has been input up to the present time point so as to increase the steering angle with a certain amount of increase. In this case, the processor 232 calculates the predictive driving operation (dotted line shown in FIG. 8) as driving operation in which the steering angle increases with the same amount of increase up to the predetermined elapsed time. The processor 232 may estimate the predictive driving operation using a Kalman filter. Furthermore, the processor 232 may be configured to consider information of the surrounding environment of the vehicle 100. For example, the processor 232 may calculate the predictive driving operation considering the shape of the road on which the vehicle 100 is traveling.

See FIG. 7 again. After Step S310, processing proceeds to Step S320.

In Step S320, the processor 232 generates the first estimate traveling path 2. The processor 232 generates the first estimate traveling path 2 based on the driving operation data 234, the traveling state data 235, and the delay time between the vehicle 100 and the remote driving device 200. As described above, the first estimate traveling path 2 shows a traveling path from the time point of taking image to the action time point. For example, the processor 232, based on the delay time, acquires information of driving operation up to the present time point which have not yet acted on the vehicle 100 at the time point of taking image. In this case, the processor 232 may acquire information of driving operation input in the driving operation device 221 from the time point before the total delay time to the present time. The processor 232 acquires information of the traveling state at the time point of taking image. In this case, the processor 232 my acquire information of the traveling state at the time point before the display delay time from the present time point. Then, the processor 232 generates the first estimate traveling path 2 so as that the acquired driving operation acts on the vehicle 100 which is in the acquired traveling state.

After Step S320, processing proceeds to Step S330.

In Step S330, the processor 232 generates the second estimate traveling path 3. The second estimate traveling path 3 is the estimate traveling path in which the vehicle 100 is estimated to travel by the predictive driving operation (calculated in Step S310). The processor 232 generates the second estimate traveling path 3 based on the driving operation data 234, the traveling state data 235, the delay time, and the predictive driving operation.

As described above, the second estimate traveling path 3 shows a traveling path after the action point. For example, the processor 232 estimates the traveling state of the vehicle 100 at the action time point based on the driving operation data 234, the traveling state data 235, and the delay time. Here, the processor 232 may calculate the action time point as the time point before the action delay time from the present time. Then, the processor 232 generates the second estimate traveling path 3 assuming that the predictive driving operation acts on the vehicle 100 after the action time point.

After Step S330, the estimate traveling path generation process ends. Incidentally, in the estimate traveling path generation process, the estimate traveling path may be given as the position data on a map. For example, the estimate traveling path is given as the position data on a two-dimensional map (like FIG. 2A).

The order of processing shown in FIG. 7 is an example, and the order of processing may be appropriately replaced. For example, prior to executing the processing of Step S310, the processing of Step S320 may be executed. As other examples, prior to executing the processing of Step S320, the processing of calculating the action time point may be executed in advance.

### 3-4. Display Process

The processor 232 executes the display process of displaying the traveling video 213 on the display device 211 (in Step S400 in FIG. 5). Here, the display process includes superimposing the first estimate traveling path 2 and the second estimate traveling path 3 on the traveling video 213. In the display process, the processor 232 converts the coordinates of the first estimate traveling path 2 and the second estimate traveling path 3 so that the estimate traveling path can be superimposed on the traveling video 213. Then, the processor 232 generates the control signal to display the traveling video 213 on the display device 211. Thus, the traveling video 213 on which the estimate traveling path is superimposed is displayed on the display device 211 (like FIG. 2B). Here, the processor 232 converts the coordinates of the first estimate traveling path 2 and the second estimate traveling path 3 typically based on the position and the model of the camera 110.

### 4. Effect

As described above, according to the remote driving device 200 of the remote driving system 10 according to the present embodiment, the traveling video 213 on which the estimate traveling path is superimposed is displayed on the display device 211. And the first traveling path 2 and the second traveling path 3 are generated considering the delay time between the vehicle 100 and the remote driving device 200. Especially, the second traveling path 3 is the estimate traveling path in which the vehicle 100 is estimated to travel by the predictive driving operation.

It is thus possible to let the operator 1 confirm continuously how the vehicle is going to travel by its own driving operation, seeing the first estimate traveling path 2 and the second estimate traveling path 3. Then, it is thus possible to reduce the difficulty of driving operation for remote driving and improve the operability of the operator 1.

Especially, the delay time may include the reaction time of the operator 1. The reaction time can be a large portion of the delay time (about quarter of the delay time). Therefore, by considering the reaction time as the delay time, it is possible to further improve the accuracy of generating the first estimate traveling path 2 and the second estimate traveling path 3.

Furthermore, according to the remote driving system 10 according to the present embodiment, the estimate traveling path is generated in the remote driving device. Therefore, the estimate traveling path is generated considering information of all driving operation input in the driving operation device 221 up to the present time point. That is, information of driving operation is not affected by communication between the vehicle 100 and the remote driving device 200. Then, it is possible to generate the estimate traveling path more accurately.

Furthermore, the second estimate traveling path 3 is generated based on the predictive driving operation. It is thus possible to let the operator 1 confirm continuously how the vehicle is estimated to travel by the tendency of driving operation. Then it is possible to improve the operability of the operator 1.

### 5. Modification

The remote driving system 10 according to the present embodiment may be modified as follows. Hereinafter, the matter already explained in the above contents will be omitted.

### 5-1. First Modification

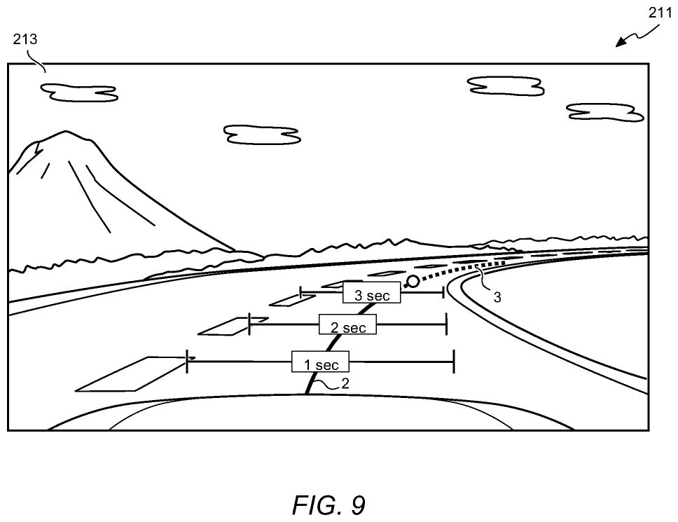

In the display process, the processor 232 may further display the time when the vehicle is expected to pass through a particular point on the estimate traveling path. FIG. 9 is a conceptual diagram showing the traveling video 213 displayed on the display device 211 in the remote driving system 10 according to the first modification of the present embodiment. As shown in FIG. 9, in the traveling video 213, the time (1 sec, 2 sec, and 3 sec) is displayed at the specific point on the estimate traveling path. The displayed time shows that the vehicle 100 is estimated to pass through these specific points after in the displayed time. It is thus possible to further improve the operability of the operator 1.

### 5-2. Second Modification

In the estimate traveling path generation process, the processor 232 may further generate a third estimate traveling path. Here, the third estimate traveling path is a traveling path after the action time point in a case where the input of driving operation at the present time point maintains up to the predetermined elapsed time. Then, the display process may include superimposing the third estimate traveling path on the traveling video 213.

For example, the processor 232 estimate the traveling state of the vehicle 100 at the action time point based on the driving operation data 234, the traveling state data 235, and the delay time. Then, the processor 232 generates the third estimate traveling path assuming that the input of driving operation at the present time point continues to act on the vehicle 100 after the action time point.

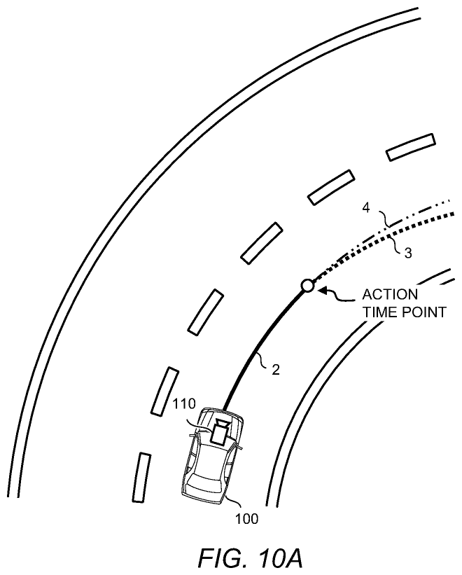

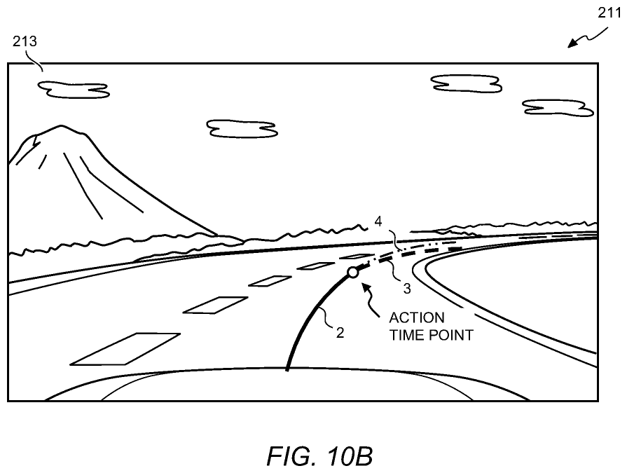

FIG. 10A and FIG. 10B are a conceptual diagram showing the traveling video 213 displayed on the display device 211 in the remote driving system 10 according to the second modification of the present embodiment. FIG. 10A and FIG. 10B show a diagram similar to that of FIG. 2A and FIG. 2B. As shown in FIG. 10A and FIG. 10B, the third estimate traveling path 4 (dashed line) is further superimposed on the traveling video 213. It is thus possible to let the operator 1 confirm how the vehicle is estimated to travel not only by the predictive driving operation but also by driving operation at the present time point. Then, it is possible to further improve the operability of the operator 1.

What is claimed is:

1. A remote driving system for a vehicle, comprising:
a camera configured to take an image of a traveling video of the vehicle;
a sensor configured to detect a traveling state of the vehicle; and
a remote driving device comprising:
a driving operation device configured to receive an input of driving operation;
a display device; and
one or more processors configured to execute:
a process of acquiring the traveling video of the vehicle;
a process of acquiring the traveling state of the vehicle;
a process of calculating a delay time relating to communication and processing between the vehicle and the remote driving device;
a process of calculating a predictive driving operation from a present time point to a predetermined elapsed time point based on the input of driving operation received up to the present time point by the driving operation device;
a process of calculating an action time point based on the delay time, the action time point being a time point when the input of driving operation at the present time point acts on the vehicle;
a process of generating a first estimate traveling path based on the traveling state, the input of driving operation received by the driving operation device, and the delay time, the first estimate traveling path being a traveling path from a time point of taking the image of the traveling video to the action time point;
a process of generating a second estimate traveling path, the second estimate traveling path being a traveling path after the action time point by the predictive driving operation; and
a display process of displaying the traveling video on the display device, wherein the display process includes superimposing the first estimate traveling path and the second estimate traveling path on the traveling video.

2. The remote driving system according to claim 1, wherein
the one or more processors are further configured to execute a process of generating a third estimate traveling path, the third estimate traveling path being a traveling path after the action time point in a case where the input of driving operation at the present time point maintains up to the predetermined elapsed time, and
the display process includes superimposing the third estimate traveling path on the traveling video.

3. The remote driving system according to claim 2, wherein
the delay time includes a reaction time of an operator operating the remote driving device.

4. A remote driving device for a vehicle, comprising:
a driving operation device configured to receive an input of driving operation;
a display device; and
one or more processors configured to execute:
a process of acquiring a traveling video of the vehicle;
a process of acquiring a traveling state of the vehicle;
a process of calculating a delay time relating to communication and processing between the vehicle and the remote driving device;
a process of calculating a predictive driving operation from a present time point to a predetermined elapsed time point based on the input of driving operation received up to the present time point by the driving operation device;
a process of calculating an action time point based on the delay time, the action time point being a time point when the input of driving operation at the present time point acts on the vehicle;
a process of generating a first estimate traveling path based on the traveling state, the input of driving operation received by the driving operation device, and the delay time, the first estimate traveling path being a traveling path from a time point of taking the image of the traveling video to the action time point;
a process of generating a second estimate traveling path, the second estimate traveling path being a traveling path after the action time point by the predictive driving operation; and
a display process of displaying the traveling video on the display device, wherein the display process includes superimposing the first estimate traveling path and the second estimate traveling path on the traveling video.

5. The remote driving device according to claim 4, wherein
the one or more processors are further configured to execute a process of generating a third estimate traveling path, the third estimate traveling path being a traveling path after the action time point in a case where the input of driving operation at the present time point maintains up to the predetermined elapsed time, and
the display process includes superimposing the third estimate traveling path on the traveling video.

6. The remote driving device according to claim 5, wherein
the delay time includes a reaction time of an operator operating the remote driving device.

7. A method of displaying a traveling video of a vehicle on a display device of a remote driving device, the remote driving device comprising a driving operation device configured to receive an input of driving operation,
the method comprising:
acquiring the traveling video of the vehicle;
acquiring a traveling state of the vehicle;
calculating a delay time relating to communication and processing between the vehicle and the remote driving device;
calculating a predictive driving operation from a present time point to a predetermined elapsed time point based on the input of driving operation received up to the present time point by the driving operation device;
calculating an action time point based on the delay time, the action time point being a time point when the input of driving operation at the present time point acts on the vehicle;
generating a first estimate traveling path based on the traveling state, the input of driving operation received by the driving operation device, and the delay time, the first estimate traveling path being a traveling path from a time point of taking the image of the traveling video to the action time point;
generating a second estimate traveling path, the second estimate traveling path being a traveling path after the action time point by the predictive driving operation; and
displaying the traveling video on the display device, wherein displaying the traveling video on the display device includes superimposing the first estimate traveling path and the second estimate traveling path on the traveling video.

8. The method according to claim 7, further comprising generating a third estimate traveling path, the third estimate traveling path being a traveling path after the action time point in a case where the input of driving operation at the present time point maintains up to the predetermined elapsed time,
wherein displaying the traveling video on the display device includes superimposing the third estimate traveling path on the traveling video.

9. The method according to claim 8, wherein
the delay time includes a reaction time of an operator operating the remote driving device.
